(19) United States
(12) Patent Application Publication
(10) Pub. No.: US 2021/0335273 A1
(43) Pub. Date: Oct. 28, 2021

(54) METHOD, DEVICE AND APPARATUS FOR ADJUSTING DISPLAY BRIGHTNESS, DISPLAY DEVICE AND STORAGE MEDIUM

(71) Applicant: BOE TECHNOLOGY GROUP CO., LTD., Beijing (CN)

(72) Inventor: Song MENG, Beijing (CN)

(21) Appl. No.: 16/474,041

(22) PCT Filed: Dec. 21, 2018
(86) PCT No.: PCT/CN2018/122802

§ 371 Date: Jun. 26, 2019

(30) Foreign Application Priority Data
May 11, 2018 (CN) 201810450476.3

(51) Int. Cl. G09G 3/3275

(52) U.S. Cl. CPC G09G 3/3275; G09G 2320/0686; G09G 2360/16; G09G 2320/0271; G09G 2330/021

(57) ABSTRACT

A method for adjusting display brightness of a display panel including: partitioning a display picture into N display areas; determining, for an i-th display area in a current frame, a brightness adjustment parameter for the i-th display area based on display data of the first to (i−1)-th display areas in the current frame; and adjusting display brightness of the i-th display area in the current frame based on the brightness adjustment parameter, wherein N and i are positive integers greater than or equal to 2, and i is less than or equal to N.

### CROSS-REFERENCE TO RELATED APPLICATIONS

The present application claims the benefit of priority right of Chinese patent application with the application No. of 201810450476.3, filed on May 11, 2018 in China, which is incorporated by reference herein in its entirety as part of the present application.

### TECHNICAL FIELD

The present disclosure relates to a method, device and apparatus for adjusting display brightness, a display device and a storage medium.

### BACKGROUND

When display brightness adjustment is performed on a self-luminous display panel, display contrast can be improved without increasing power consumption by means of adjusting brightness of respective sub-pixels in a display picture. For example, a power consumption condition of a current frame of display picture may be determined according to display data of a previous picture, and brightness of a next frame of display picture may be adjusted according to the power consumption condition of the current frame. However, in the case where a power consumption difference between two consecutive frames of display picture is large, there may be a problem of causing display consumption of the latter frame to be excessively large if display data of the latter frame is adjusted based on display data of the former frame, resulting in power down of the power supply.

### SUMMARY

According to an aspect of the present disclosure, there is provided a method for adjusting display brightness of a display panel, comprising: partitioning a display picture into N display areas; determining, for an i-th display area in a current frame, a brightness adjustment parameter for the i-th display area based on display data of the first to (i−1)-th display areas in the current frame; and adjusting display brightness of the i-th display area in the current frame based on the brightness adjustment parameter, wherein N and i are positive integers greater than or equal to 2, and i is less than or equal to N.

According to some embodiments of the present disclosure, determining, for an i-th display area in a current frame, a brightness adjustment parameter for the i-th display area based on display data of the first to (i−1)-th display areas in the current frame comprises: determining first brightness statistical data based on display data of the first to (i−1)-th display areas in the current frame, and determining second brightness statistical data based on display data of display areas in a previous frame; and determining the brightness adjustment parameter based on the first brightness statistical data and the second brightness statistical data that are determined.

According to some embodiments of the present disclosure, determining first brightness statistical data comprises: determining, for each display area of the first to (i−1)-th display areas in the current frame, brightness statistical data of the display area based on display data of the display area, respectively; determining the first brightness statistical data based on the brightness statistical data of each display area among the first to (i−1)-th display areas in the current frame as determined.

According to some embodiments of the present disclosure, determining second brightness statistical data comprises: determining the second brightness statistical data based on display data of the i-th to N-th display areas in the previous frame.

According to some embodiments of the present disclosure, determining second brightness statistical data further comprises: determining, for each display area of the i-th to N-th display areas in the previous frame, brightness statistical data of the display area based on display data of the display area, respectively; determining the second brightness statistical data based on the brightness statistical data of each display area of the i-th to N-th display areas in the previous frame as determined.

According to some embodiments of the present disclosure, for each display area, the brightness statistical data thereof comprises at least one type of the following data: a sum of display data at respective pixels in the display area; the number of pixels where display data exceeds a set threshold in the display area.

According to some embodiments of the present disclosure, determining the brightness adjustment parameter based on the first brightness statistical data and the second brightness statistical data that are determined comprises: summing the first brightness statistical data and the second brightness statistical data to determine total brightness statistical data; determining, according to a preset mapping relationship, a brightness adjustment parameter corresponding to the total brightness statistical data, and using the determined brightness adjustment parameter as the brightness adjustment parameter for the i-th display area in the current frame.

According to some embodiments of the present disclosure, the display picture is determined to be partitioned into the N areas in the horizontal or vertical direction based on a driving manner of the pixels in the display picture.

According to some embodiments of the present disclosure, N=8.

According to another aspect of the present disclosure, there is further provided a device for adjusting display brightness of a display panel, comprising: one or more processors; one or more memories, wherein the memory is stored with computer-readable codes that, when being run by the one or more processors, execute the method mentioned above.

According to another aspect of the present disclosure, there is further provided an apparatus for adjusting display brightness of a display panel, comprising: a partitioning module configured to partition a display picture into N display areas; a brightness adjustment parameter determining module configured to determine, for an i-th display area in a current frame, a brightness adjustment parameter for the i-th display area based on display data of the first to (i−1)-th display areas in the current frame; and an adjusting module configured to adjust display brightness of the i-th display area in the current frame based on the brightness adjustment parameter, wherein N and i are positive integers greater than or equal to 2, and i is less than or equal to N.

According to another aspect of the present disclosure, there is further provided a display device, comprising the apparatus for adjusting display brightness of a display panel mentioned above.

According to another aspect of the present disclosure, there is further provided a non-transitory computer-readable storage medium having stored therein computer-readable codes that, when run by one or more processors, execute the method for adjusting display brightness of a display panel mentioned above.

### BRIEF DESCRIPTION OF THE DRAWINGS

In order to more clearly illustrate the technical solutions in the embodiments of the present disclosure or in the prior art, drawings necessary for describing the embodiments or the prior art will be briefly introduced below, obviously, the below described drawings are only some embodiments of the present disclosure, for those skilled in the art, other drawings may also be obtained based on these drawings without paying creative efforts.

FIG. 1 illustrates a schematic diagram of adjusting display brightness by the peak brightness algorithm in the prior art;

FIG. 2 illustrates a flow chart of the method for adjusting display brightness according to some embodiments of the present disclosure;

FIG. 3 illustrates a flow chart of determining the first brightness statistical data according to some embodiments of the present disclosure;

FIG. 4 illustrates a flow chart of determining the second brightness statistical data according to some embodiments of the present disclosure;

FIG. 5 illustrates a schematic diagram of partitioned display areas according to some embodiments of the present disclosure;

FIG. 6 illustrates a schematic diagram of adjusting display brightness using the method for adjusting display brightness according to some embodiments of the present disclosure;

FIG. 7 illustrates a schematic diagram of effect of adjusting display brightness using the method for adjusting display brightness according to some embodiments of the present disclosure;

FIG. 8 illustrates a schematic block diagram of a device for adjusting display brightness according to some embodiments of the present invention; and

FIG. 9 illustrates a schematic block diagram of an apparatus for adjusting display brightness according to some embodiments of the present disclosure.

### DETAILED DESCRIPTION OF THE EMBODIMENTS

Hereinafter, the technical solutions in the embodiments of the present disclosure will be described clearly and comprehensively in combination with the drawings thereof, obviously, these described embodiments are only parts of the embodiments of the present disclosure, rather than all of the embodiments thereof, all the other embodiments obtained by those of ordinary skill in the art based on the embodiments of the present disclosure without paying creative efforts fall into the protection scope of the present disclosure.

Words and expressions such as “first”, “second” and the like used in the present disclosure do not denote any sequence, quantity or priority, but are used only to distinguish different components. Likewise, words such as “include”, “comprise” and the like refer to that an element or an object before this word contains all the elements or objects listed thereinafter or alternatives thereof, without excluding other elements or objects. Words such as “connected”, “connecting” and the like are not restricted to physical or mechanical connections, but may include electrical connections, regardless of direct or indirect connections.

The flow chart is used in the present application to illustrate steps of the method according to some embodiments of the present application. It should be understood that the preceding or subsequent steps may not be necessarily performed precisely in order. Instead, the respective steps may be processed in reverse order or simultaneously. At the same time, other operations may be added to these processes, or one or several steps may be removed from these processes.

In the field of display, an organic light emitting diode (OLED) is a self-luminous display device. OLED requires no backlight and is made of a very thin coating of organic materials and a glass substrate, these organic materials emit light when current passes through. OLED display technology has the advantages of self-illumination, wide viewing angle, high contrast, low power consumption, high response speed, etc., making the OLED display screen lighter and thinner, with larger viewing angle, higher contrast, and it can significant save electrical energy. The active matrix organic light emitting diode (AMOLED) display panel, which originated from OLED display technology, has a self-luminous display characteristic, and has the advantages of low power consumption, high contrast, and fast response speed.

In the display panel using the self-luminous display technology, since each pixel emits light alone, its power consumption is directly related to the display data in the display picture. Applying the peak brightness algorithm to the self-luminous display panel can adjust brightness of the respective sub-pixels, thereby improve contrast of the display picture without increasing power consumption. The main flow of the aforementioned peak brightness algorithm is: detecting display data in the display picture, calculating a gain value based on the display data, and adjusting display brightness of the panel based on the gain value. The final achieved effect of the peak brightness algorithm is: in the case where the screen display area is large and the overall power consumption is high, a small gain value is outputted to adjust the display brightness so as to ensure that the power consumption will not be too large and will not exceed a normal range; in the case where the screen display area is small and the overall power consumption is low, a large gain value is outputted to adjust the display brightness so that peak brightness of the display picture reaches a higher value, thereby achieving higher display contrast and better display effect.

Specifically, the above-mentioned peak brightness algorithm generally calculates a sum of the display data (such as the grayscale value of the pixel) of one frame, determines a power consumption situation of the display picture in the current frame based on the calculated sum data, and calculates a gain, thereby adjust the display brightness. One of the implementation manners of the above-mentioned peak brightness algorithm is that after displaying of the current frame is completed, display data of the current frame is calculated and a gain value (Gain) is generated, the gain value calculated based on the display data of the current frame is applied to adjustment of the display data of the next frame of display picture.

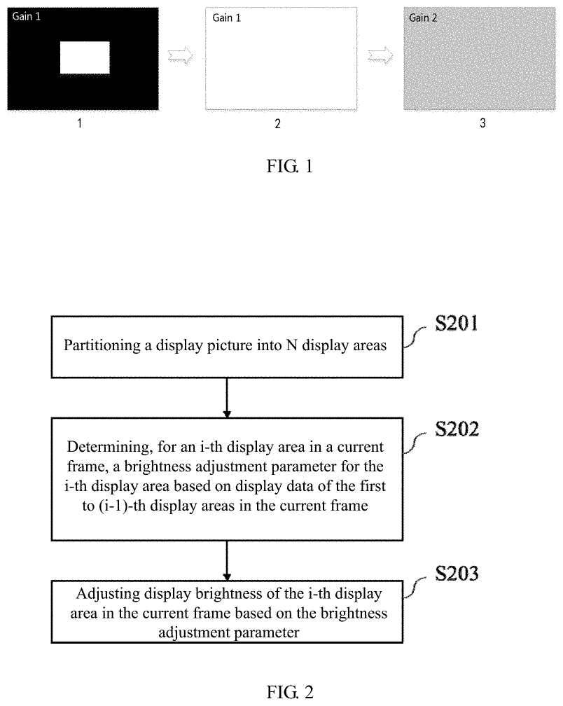

However, in this implementation manner, the disadvantage lies in that the gain value calculated based on the current frame functions on one frame's delay, that is, the gain value generated from display data of the previous frame is applied to the display data of the next frame. In the case where a power consumption difference between the two consecutive frames is large, there is a possibility that the power consumption of the adjusted display picture exceeds a limit, and power off may occur to the power supply. FIG. 1 illustrates a schematic diagram of adjusting the display data based on the above implementation manner.

As shown in FIG. 1, in the display picture of the first frame, the brightness value of the pixels located in the central window portion is high, and the brightness value of the pixels in the remaining portions is low, for example, the brightness value of the pixels in the window portion is 255, the brightness value of the pixels in the remaining portions is 0, then the gain value calculated based on the display data of the first frame is large; when the brightness values of all the pixels in the display frame of the second frame are high, for example, the display data of the full screen is 255, applying a gain value Gain1 calculated based on the first frame to the second frame cannot adjust the brightness value of the pixels reasonably, may even cause the display brightness of the second frame to be too high and the power consumption to exceed a limit. When a gain value Gain2 is calculated based on the display data of the second frame, since the display brightness of the second frame is high, a small Gain2 is obtained, and when Gain2 is applied to adjust the display data of the third frame, it will appropriately lower the brightness value of the pixels of the third frame. As can be known, such adjustment implementation manner of adjusting by the gain value on one frame's delay may cause a too high display power consumption of a certain frame when two consecutive frames have a great display data difference, and power off may occur to the power supply.

Another implementation manner of the peak brightness algorithm is to buffer one frame of display data in advance by adding hardware, such as a buffer memory, calculate, based on the display data of the frame buffered, the gain value of this frame, then display the display data that has been adjusted based on the gain value of this frame, so that the calculated gain value is synchronized with the display picture, thereby avoiding problems that may occur with the delayed function of the gain value. The disadvantage of this implementation manner is that it requires a buffer device with a large capacity to be added, which increases the cost, and the buffered display picture will be displayed on one frame's delay.

The present disclosure provides a method for adjusting display brightness, FIG. 2 illustrates a flow chart of the method according to some embodiments of the present disclosure.

As shown in FIG. 2, first, in step S201, a display picture is partitioned into N display areas, wherein N is a positive integer greater than or equal to 2. In some embodiments, the value of N can be determined based on the number of pixels contained in the display screen. For example, when the number of pixels contained in the display screen is relatively large (e.g., exceeding a preset threshold), each frame of display picture may be partitioned into eight areas. Alternatively, when the number of pixels contained in the display picture is relatively small (e.g., below a preset threshold), the display picture may be partitioned into four areas.

Next, in step S202, for an i-th display area in a current frame, a brightness adjustment parameter for the i-th display area is determined based on display data of the first to (i−1)-th display areas in the current frame, wherein i is a positive integer greater than or equal to 2 and less than or equal to N.

For example, when N is 8, the display picture of each frame is partitioned into eight display areas, and the partitioned display areas are displayed one by one, and in the case where i is 5, the brightness adjustment parameter of the fifth display area in the current frame is determined based on the display data of the first to fourth display areas in the current frame.

In some embodiments, determining a brightness adjustment parameter for the i-th display area based on display data of the first to (i−1)-th display areas in the current frame may comprise: for the i-th display area in the current frame, determining first brightness statistical data based on display data of the first to (i−1)-th display areas in the current frame, and determining second brightness statistical data based on display data of display areas in a previous frame; and determining the brightness adjustment parameter based on the first brightness statistical data and the second brightness statistical data that are determined.

For example, in the case where i is 5, the first brightness statistical data is calculated based on the display data of the first to fourth display areas in the current frame.

In some embodiments, the second brightness statistical data may be determined based on the display data of at least a portion of the display areas of the previous frame. For example, the second brightness statistical data may be determined using display data of the i-th to N-th display areas in the previous frame. In some embodiments, the greater the value of the brightness statistical data mentioned herein is, the brighter the display picture is.

Thereafter, in step S203, the display brightness of the i-th display area in the current frame may be adjusted based on the brightness adjustment parameter.

The brightness adjustment parameter is determined according to the first brightness statistical data determined based on display data of the first to (i−1)-th display areas in the current frame and the second brightness statistical data determined based on display data of the display areas in the previous frame, and display brightness of the respective pixels in the i-th display area in the current frame is adjusted according to the determined brightness adjustment parameter. That is, in the case of partitioned display, the display data of the i-th display area to be displayed in the current frame is adjusted based on the display data of the display areas that have been displayed in the current frame and the display data of at least part of the display areas of the previous frame.

Through the partitioned display and adjustment of the display picture, it avoids problems that may arise from the adjustment value functions on one frame's delay in the case where a large brightness difference exists between two consecutive frames, as shown by the first frame and the second frame in FIG. 1, the brightness statistical data calculated based on the display data of the first frame adjusts only the display data of the first display area in the second frame, even if the difference between the two is large, brightness of the first display area in the second frame is only effected, and display data of the subsequent display areas are adjusted based on the already-displayed display areas of the current second frame as well as part of the display areas in the first frame, which avoids the problem of excessive power consumption caused by adjustment delay of the entire frame of picture.

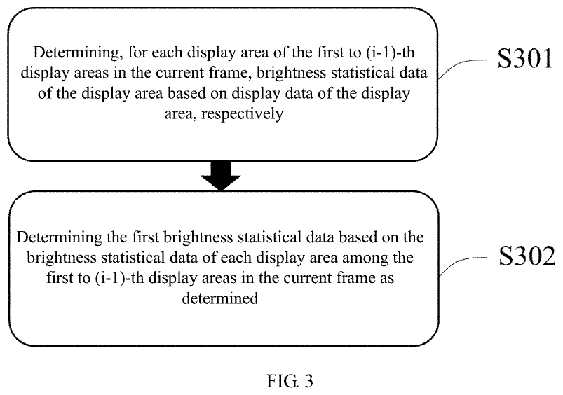

FIG. 3 illustrates a flow chart of determining the first brightness statistical data according to some embodiments of the present disclosure. First, in step S301, for each display area of the first to (i−1)-th display areas in the current frame, brightness data of the display area may be determined based on display data of the display area, respectively. That is, for each display area of the i−1 display areas that have been displayed in the current frame, brightness data corresponding to the display data of the display area is calculated respectively, and values of i−1 brightness data are obtained. In some embodiments, the display data of the display area may be a grayscale value of each pixel in the display area.

In some embodiments, by partitioning each frame of display picture into N display areas, the brightness data of each display area may be determined respectively, and the brightness data of each display area is separately stored for determining brightness statistical data.

Next, in step S302, the first brightness statistical data may be determined based on brightness data of each display area among the first to (i−1)-th display areas in the current frame as determined. For example, a summed value of adding the brightness data of each display area described above may be determined as the first brightness statistical data. That is, the first brightness statistical data is the sum of i−1 brightness data of the first ti (i−1)-th display areas calculated in step S301.

It should be noted that summing the respective brightness data to generate brightness statistical data is merely some embodiments of the present disclosure and does not constitute a limitation to the present disclosure. For example, it is also possible to determine, according to a set first threshold, the first brightness statistical data reflecting a display situation of the current frame of display picture, for example, counting the number of display areas whose brightness data is higher than the set first threshold in the current frame.

The first brightness statistical data calculated based on the brightness data of each display area of the first to (i−1)-th display areas in the current frame reflects the display situation of the aforesaid display areas in the current frame, and the aforesaid first brightness statistical data may be used to determine a brightness adjustment parameter for adjusting display data of the i-th display area.

According to some embodiments of the present disclosure, the second brightness statistical data is determined based on display data of at least one display area in the previous frame. The at least one display area may be determined based on a display sequence of the display area i to be adjusted in the current frame. For example, when i is small (e.g., when N is 8 and i is 2), the number of display areas in the previous frame for determining the second brightness statistical data may be increased, for example, the display data of the second to eighth display areas in the previous frame is used to calculate the second brightness statistical data. When i is large (e.g., when N is 8 and i is 7), the number of display areas in the previous frame for determining the second brightness statistical data may be appropriately reduced, for example, the display data of the seventh to eighth display areas in the previous frame is used to calculate the second brightness statistical data.

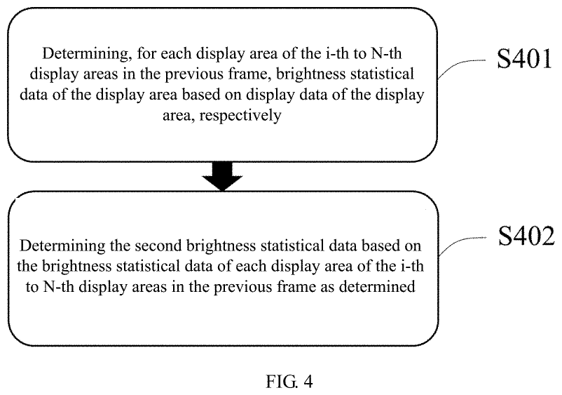

FIG. 4 illustrates a specific flow chart of determining the second brightness statistical data according to some embodiments of the present disclosure, wherein, in step S401, for each display area of the i-th to N-th display areas in the previous frame, brightness data of the display area is determined based on display data of the display area, respectively. Similar to step S301, that is, for each display area of the i-th to N-th display areas that have been displayed in the previous frame, the brightness data corresponding to the display data of the display area is calculated respectively, and number of the obtained value of the brightness data is N-i+1.

Next, in step S402, the second brightness statistical data may be determined based on the brightness data of each display area of the i-th to N-th display areas in the previous frame as determined. For example, a summed value of the brightness data of each display area described above may be determined as the second brightness statistical data. That is, the second brightness statistical data is the sum of N-i+1 brightness data of the previous frame calculated in step S401.

It should be noted that, herein summing the brightness data of respective display areas serves as only one of the embodiments according to the present disclosure, and does not constitute a limitation to the present disclosure. For example, it is also possible to determine the second brightness statistical data reflecting a display situation of the display picture of the previous frame based on a set second threshold, such as counting the number of display areas whose brightness data is higher than the set second threshold in the previous frame. The second threshold set herein may be the same as or different from the first threshold set in step S301.

For each display area partitioned according to some embodiments of the present disclosure, the brightness data thereof may be a sum of display data of respective pixels in the display area. At this time, the brightness data directly reflects the overall brightness of the display area, for example, when the display area is all white, the brightness data may be a product of the number of pixels included in the area and the current brightness value of the pixels.

The brightness data of each display area mentioned above may be calculated based on a set third threshold, for example, the third threshold may be set as 125, and the number of pixels in the display area exceeding the third threshold 125 may be counted, and the counted number serves the brightness data of the display area.

It should be noted that the above method for determining the brightness data by summing the displaying data or by counting the number of pixels exceeding the set third threshold in the display area serves only as some embodiments according to the present disclosure, and other manners may be also adopted to determine the brightness data reflecting the display situation of the display area. For example, the brightness data may be determined by adopting the means of setting a segmented threshold, that is, a plurality of thresholds are set to divide the display data into a plurality of brightness interval ranges, and the number of pixels in each brightness interval is separately counted as the brightness data of the display area. For example, a histogram algorithm may also be adopted to determine the brightness data, which will not be detailed herein.

In addition, during calculating the first or the second brightness statistical data, all the methods for calculating brightness data described above may be used to some embodiments according to the present disclosure, for example, when calculating the first brightness statistical data based on the display data of the first to i-th display areas of the current frame, the same method of determining the brightness data should be adopted for each of the display areas, for example, summing the display data is adopted to calculate the brightness data of each display area.

In the method for adjusting brightness according to the embodiment of the present disclosure, determining the brightness adjustment parameter based on the first brightness statistical data and the second brightness statistical data that are determined comprises: summing the first brightness statistical data and the second brightness statistical data to determine total brightness statistical data; determining, according to a preset mapping relationship, a brightness adjustment parameter corresponding to the total brightness statistical data, and using the determined brightness adjustment parameter as the brightness adjustment parameter for the i-th display area in the current frame. Herein, the total brightness statistical data is data reflecting the display situation of the display pictures corresponding to the first brightness statistical data and the second brightness statistical data, and the brightness adjustment value calculated based on the total brightness statistical data may be the coefficient or function applied to the display data of the display area to be adjusted (e.g., the i-th display area), the display data of the i-th display area is adjusted to an appropriate range according to the brightness adjustment value, thereby increasing the contrast of the display picture and avoiding too high power consumption caused by one frame delay of the adjustment value. Adjusting the display brightness of the display area based on the brightness adjustment parameter may also be implemented based on other already-existing techniques in the art, which is not enumerated herein, and does not constitute a limitation to the present disclosure.

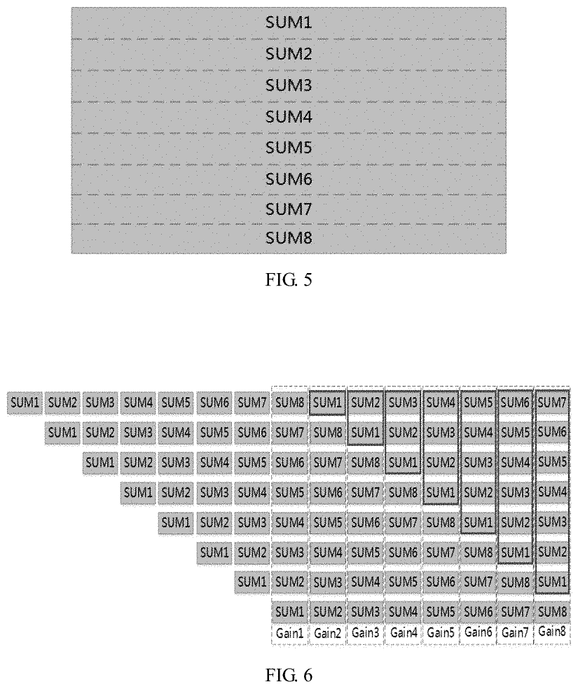

According to some embodiments of the present disclosure, it is possible to determine to partition the display picture into the N regions in the horizontal or vertical direction based on a driving manner of the pixels in the display picture. The current display screen generally adopts a progressive scanning manner to drive pixels of one frame of display picture, FIG. 5 shows a schematic diagram of partitioning the display area in the horizontal direction according to some embodiments of the present disclosure.

FIG. 5 shows a case where N is 8, that is, the display picture is partitioned into eight display areas in the horizontal direction, and the respective display areas are displayed one by one. According to some embodiments of the present disclosure, each SUM value therein may be used as brightness data of the display area, for example, SUM1 may be determined as brightness data of the first display area of the current frame.

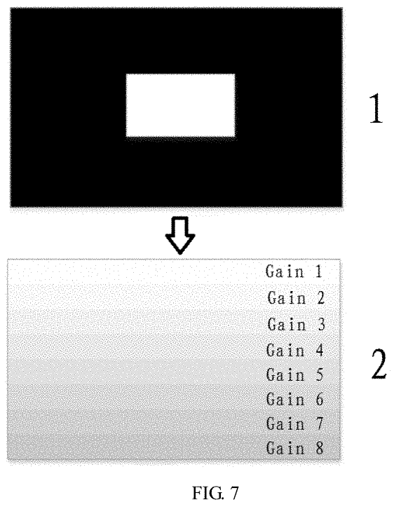

FIG. 6 shows a schematic diagram of adjusting display brightness by the method for adjusting display brightness according to some embodiments of the present disclosure, and FIG. 7 is a schematic diagram showing the effect of adjusting display brightness by the method illustrated in FIG. 6. The method for adjusting display brightness according to the present disclosure will be exemplarily described in detail below with reference to FIGS. 6 and 7.

According to some embodiments of the present disclosure, the display picture is first partitioned into N display areas, and partitioned display is performed. For example, as shown in FIG. 5, the display picture is partitioned into eight display areas in the horizontal direction. As shown in FIG. 6, when the first frame of display data starts to be displayed, the first display area is displayed first, then the brightness data of the first display area is calculated, for example, the display brightness values of all the pixels in the first display area are summed to obtain a value SUM1, thereafter, the second display area is displayed, the brightness data SUM2 based on the sum of the display brightness values of all the pixels in the second display area are calculated, and so on, and so forth. When the display data of the first frame is all displayed, the brightness data SUM1 to SUM8 of the respective display areas in the first frame of display picture can be calculated. Based on the brightness statistical SUM1 to SUM8 of the first frame of display data, the overall brightness statistical data Gain1 of the first frame can be obtained. For example, the aforementioned brightness statistical values SUM1 to SUM8 may be summed to obtain total brightness statistical data, and a gain value Gain1 corresponding to the total brightness statistical data may be determined based on a preset mapping relationship. Next, the display screen is to display the first display area of the second frame of display picture, in this case, the second frame is the current frame, first, brightness of each pixel in the first display area of the second frame is adjusted using Gain1 that is determined based on the first frame of display data, then the display data of the first display area that has been subjected to brightness adjustment is displayed.

Next, the brightness data of the first display area of the second frame of display picture is calculated as a new SUM1. At this time, for the second display area of the second frame of display picture to be displayed, a brightness adjustment value Gain2 is determined based on the first brightness data SUM1 of the first display area of the current frame (that is, SUM1 shown in the solid line box in FIG. 6) and the second brightness statistical data SUM2 to SUM8 of the second to eighth display areas of the previous frame, and brightness of each pixel in the second display area of the current frame is adjusted based on Gain2. For example, the first brightness data SUM1 of the first display area of the current frame and the second brightness statistical data SUM2 to SUM8 of the second to eighth display areas of the previous frame may be summed to obtain total brightness statistical data, and a gain value Gain2 corresponding to the total brightness statistical data is determined based on the preset mapping relationship.

By analogy, the brightness data of the second display area of the second frame of display picture is calculated as the new SUM2, as for the third display area of the second frame of display picture to be displayed, the brightness adjustment value Gain3 is determined based on the first brightness statistical data SUM1 to SUM2 of the first to second display areas of the current frame (i.e., SUM1 to SUM2 shown in the solid line box in FIG. 6) and the second brightness statistical data SUM3 to SUM8 of the third to eighth display areas of the previous frame, and the brightness of each pixel in the third display area of the current frame is adjusted based on Gain3.

The above steps are repeated until displaying of the second frame of display picture is completed, Gain 8 calculated based on the display data of the second frame of display picture is used to adjust the brightness of each pixel in the first display area of the third frame of display picture.

As can be known, in the method for adjusting brightness according to the embodiment of the present disclosure, only brightness of the first display area of each frame is adjusted totally based on the brightness statistical data of the display picture of the previous frame, for the display areas except the first display area, a brightness adjustment parameter may be determined based on the display data of the display areas that have already been displayed in the current frame, this brightness adjustment parameter is for adjusting brightness of each pixel in the display area to be displayed.

In the actual application, the above method for adjusting brightness is, in its entire implementation process, similar to a pipeline operation. As the display data flows in, the brightness data of each display area is calculated. After displaying of one frame of data is completed, a summed value may be obtained according to the 8 brightness data, the summed value reflects the brightness display situation of the frame and the display power consumption, thereby a Gain1 value for adjusting the display brightness is determined. After the data of the first area of the second frame flows in, a new SUM1 value is generated, and this SUM1 value will replace the SUM1 value of the previous frame, and the eight SUM values are summed, and a new Gain2 value is obtained according to the total brightness statistical data produced from summing. When displaying of the second display area is completed, a Gain3 value is generated, and so on, and so forth, and as the display data of each display area continues to flow in, the effect of brightness adjustment for each display area is achieved. The SUM value determined for each area is stored separately.

In the above embodiment, it should be noted that the eight display areas described herein are merely exemplary, and the display picture may be partitioned into other numbers of display areas. Moreover, in the above embodiment, the display data is summed to calculate the brightness data of each display area, and to generate the Gain value. In the actual application, the Gain value may be generated in other manners, for example, as described above, by means of setting a threshold, then counting the number of pixels that exceed the threshold so as to determine the brightness statistical data.

As shown in FIG. 7, the unadjusted first frame of display picture has a high brightness value in the middle rectangular portion, for example, the brightness value is 255, and have a low brightness value in the remaining pixels, for example, the brightness value is 0, the unadjusted second frame of display picture has a high brightness value in full screen. As described based on FIG. 1, the peak brightness algorithm that functions on one frame's delay will cause the brightness of the adjusted display picture of the second frame to be too high, and the power consumption thereof to exceed a limit. If the method for adjusting brightness according to the embodiment of the present disclosure described above with respect to FIG. 6 is adopted, that is, Gain1 is generated based on the first frame of display picture, and the display data of the first display area of the second frame is adjusted by using Gain1. It can be seen that since the overall brightness of the first frame of display picture is low, the Gain1 value obtained at this time is large, when the display data of the first display area of the second frame is adjusted by using Gain1, the brightness of the first display area of the second frame is made high. However, since the display brightness of the second display area of the second frame is adjusted by the new SUM1 and the SUM2 to SUM8 of the previous frame, and since the brightness of the first display area is high, the new SUM1 value generated is also high, which causes the generated value of Gain2 to be smaller than the value of Gain1, so that brightness of the second display area is lower than that of the first display area, and so on, and so forth, with the inflow of the display data of the display area of the second frame, the Gain value is constantly changing, the newly generated Gain value is continuously applied to the display area which is subsequently displayed, and in the second frame of display picture as shown in FIG. 7, the brightness gradient effect of the respective areas appear.

Power consumption of the second frame of display picture obtained after subjecting to partitioned display and applying the method of calculating the Gain value per display area is significantly lower than power consumption of the second frame of display picture in FIG. 1, that is, the instantaneous too large power consumption problem caused by that the Gain value functions on one frame's delay is solved.

The specific implementation manner in which the display picture is dynamic is described above with reference to FIG. 6 and FIG. 7, it should be noted that in the case of static display picture switching, the effect of partitioned display will appear only in the first frame, the time is short, it makes the human eyes difficult to detect, so it does not affect the display effect. In the case of dynamic display picture, since the display pictures of two consecutive frames do not change much, it is difficult for the human eyes to perceive partitioned display of the display picture.

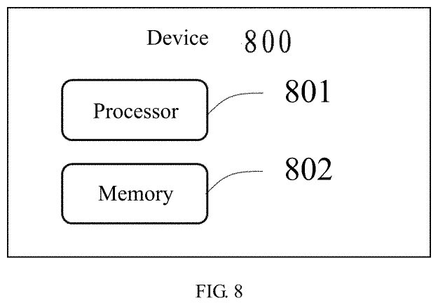

Some embodiments of the present disclosure further provides a device 800 for adjusting display brightness, its structural block diagram is shown in FIG. 8, it comprises a processor 801 and a memory 802. It should be noted that structure of the device 800 shown in FIG. 8 is merely exemplary and not restrictive, the device 800 may have other components depending on actual application needs.

In some embodiments of the present disclosure, the processor 801 and the memory 802 can communicate with each other directly or indirectly. Communication between components such as the processor 801 and the memory 802 can be made through a network connection. The network may include a wireless network, a wired network, and/or any combination of a wireless network and a wired network. The network may include a local area network, the Internet, a telecommunications network, an Internet of Things based on Internet and/or telecommunications network, and/or any combination of the above networks, and the like. The wired network can communicate by means of for example twisted pair, coaxial cable or optical fiber transmission, the wireless communication network may for example adopt 3G/4G/5G mobile communication network, Bluetooth, Zigbee or WiFi. The present disclosure does not limit the type and function of the network.

The processor 801 can control other components in the device 800 to perform the desired functions. The processor 801 may be devices having data processing capability and/or program execution capability, such as a central processing unit (CPU), a tensor processing unit (TPU) or a graphics processor GPU etc. The central processing unit (CPU) may be an X86 or ARM architecture or the like. The GPU may be integrated directly into the motherboard or built into the Northbridge of the motherboard. The GPU may also be built into the central processing unit (CPU).

The memory 802 may include any combination of one or more computer program products, which can include various forms of computer-readable storage medium, such as volatile memory and/or nonvolatile memory. The volatile memory may for example include random access memory (RAM) and/or caches and the like. The non-volatile memory may for example include read only memory (ROM), hard disk, erasable programmable read only memory (EPROM), portable compact disk read only memory (CD-ROM), USB memory, flash memory, and the like.

One or more computer-readable codes or instructions may be stored on the memory 802, and the processor 801 can execute the computer instructions to perform the method for adjusting display brightness described above. For detailed description of the device, reference may be made to the related description of the method in this specification, and details will not be repeated herein. Various applications and various data may also be stored in the computer-readable storage medium.

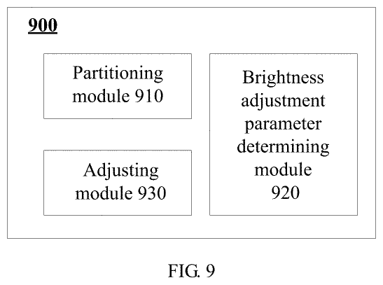

FIG. 9 illustrates a schematic block diagram of an apparatus for adjusting display brightness of a display panel according to some embodiments of the present disclosure. As shown in FIG. 9, the apparatus 900 may comprise a partitioning module 910, a brightness adjustment parameter determining module 920 and an adjusting module 930. In some embodiments, the apparatus 900 may be effectuated through the device comprising a processor and a memory shown in FIG. 8.

The partitioning module 910 may be configured to partition a display picture into N display areas, wherein N is a positive integer greater than or equal to 2. In some embodiments, the value of N can be determined based on the number of pixels contained in the display picture. For example, when the number of pixels contained in the display picture is relatively large (e.g., exceeding a preset threshold), each frame of display picture may be partitioned into eight areas. Alternatively, when the number of pixels contained in the display picture is relatively small (e.g., below a preset threshold), the display picture may be partitioned into four areas.

The brightness adjustment parameter determining module 920 may be configured to determine, for an i-th display area in a current frame, a brightness adjustment parameter for the i-th display area based on display data of the first to (i−1)-th display areas in the current frame, wherein i is a positive integer greater than or equal to 2 and less than or equal to N.

In some embodiments, the brightness adjustment parameter determining module 920 may be further configured to: for the i-th display area in a current frame, determine first brightness statistical data based on display data of the first to (i−1)-th display areas in the current frame.

For example, the brightness adjustment parameter determining module 920 may be configured to determine, for each of the first to (i−1)-th display areas in the current frame, brightness data of the display area based on display data of the display area respectively. That is, for each display area of the i−1 display areas that have been displayed in the current frame, brightness data corresponding to the display data of the display area is calculated respectively, and values of i−1 brightness data are obtained. In some embodiments, the display data of the display area may be a grayscale value of each pixel in the display area.

Further, the brightness adjustment parameter determining module 920 may be configured to determine the first brightness statistical data based on brightness data of each display area among the first to (i−1)-th display areas in the current frame as determined. For example, a summed value of adding the brightness data of each display area described above may be determined as the first brightness statistical data. That is, the first brightness statistical data is the sum of i−1 brightness data of the current frame.

In some embodiments, the brightness adjustment parameter determining module 920 may be configured to determine the second brightness statistical data based on the display data of at least a portion of the display areas of the previous frame. For example, the second brightness statistical data may be determined using display data of the i-th to N-th display areas in the previous frame. In some embodiments, the greater the value of the brightness statistical data mentioned herein is, the brighter the display picture is.

For example, the brightness adjustment parameter determining module 920 may be further configured to determine the second brightness statistical data based on display data of at least one display areas in the previous frame. The at least one display area may be determined based on a display sequence of the display area i to be adjusted in the current frame. For example, when i is small (e.g., when N is 8 and i is 2), the number of display areas in the previous frame for determining the second brightness statistical data may be increased, for example, the display data of the second to eighth display areas in the previous frame is used to calculate the second brightness statistical data. When i is large (e.g., when N is 8 and i is 7), the number of display areas in the previous frame for determining the second brightness statistical data may be appropriately reduced, for example, the display data of the seventh to eighth display areas in the previous frame is used to calculate the second brightness statistical data.

The adjusting module 930 may be configured to adjust display brightness of the i-th display area in the current frame based on the brightness adjustment parameter, wherein N and i are positive integers greater than or equal to 2, and i is less than or equal to N.

In some embodiments, the adjusting module 930 may be configured to determine the brightness adjustment parameter according to the first brightness statistical data determined based on display data of the first to (i−1)-th display areas in the current frame and the second brightness statistical data determined based on display data of the display area in the previous frame, and adjust display brightness of the respective pixels in the i-th display area in the current frame according to the determined brightness adjustment parameter. That is, in the case of partitioned display, the display data of the i-th display area to be displayed in the current frame is adjusted based on the display data of the display areas that have been displayed in the current frame and the display data of at least part of the display areas of the previous frame.

In some embodiments, by partitioning each frame of display picture into N display areas, the brightness data of each display area may be separately determined respectively, and the brightness data of each display area is separately stored in the memory of the apparatus 900, for determining brightness statistical data

According to another aspect of the present disclosure, there is further provided a display device, comprising the apparatus for adjusting display brightness of a display panel as described above. The display device can implement, by the apparatus, the display brightness adjustment function according to the embodiment of the present disclosure.

According to another aspect of the present disclosure, there is further provided a non-transitory computer-readable storage medium having stored therein computer-readable codes that, when run by one or more processors, execute the method for adjusting display brightness of a display panel as described above.

A computer-readable medium may take many forms, including tangible storage medium, carrier medium or physical transmission medium etc. Stable storage medium may include optical or magnetic disks, as well as storage systems used in other computers or similar devices and capable of implementing the system components described in the drawings. Unstable storage medium may include dynamic memory, such as main memory of a computer platform. Tangible transmission medium may include coaxial cable, copper cable, and optical fiber, such as lines forming a bus within a computer system. Carrier transmission medium can transmit an electrical signal, an electromagnetic signal, an acoustic signal, or a light wave signal. These signals can be generated by methods of radio frequency or infrared data communication. Typical computer-readable medium includes hard disk, floppy disk, magnetic tape, any other magnetic medium; CD-ROM, DVD, DVD-ROM, any other optical medium; perforated card, any other physical storage medium containing an aperture pattern; RAM, PROM, EPROM, FLASH-EPROM, any other memory slice or tape; carrier for transmitting data or instructions, cable, or connection devices for transmitting carrier, any other program codes and/or data that can be read by a computer. Many of these forms of computer-readable medium appear in the process during which the processor executes instructions, and passes one or more results.

The present disclosure provides a method, device and apparatus for adjusting display brightness, a display device and a storage medium. The method comprises: partitioning a display picture of each frame into N display areas, and carrying out partitioned display; determining, for an i-th display area in a current frame, a brightness adjustment parameter for the i-th display area based on display data of the first to (i−1)-th display areas in the current frame; and adjusting display brightness of the i-th display area in the current frame based on the brightness adjustment parameter, wherein N and i are positive integers greater than or equal to 2, and i is less than or equal to N. Accordingly, more accurate display brightness adjustment is achieved, display contrast is improved without increasing power consumption, and the instantaneous too large power consumption problem caused by that the Gain value functions on one frame's delay is solved, better display effect is achieved.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The above is illustration of the present disclosure and should not be construed as making limitation thereto. Although some exemplary embodiments of the present disclosure have been described, a person skilled in the art can easily understand that many modifications may be made to these exemplary embodiments without departing from the creative teaching and advantages of the present disclosure. Therefore, all such modifications are intended to be included within the scope of the present disclosure as defined by the appended claims. As will be appreciated, the above is to explain the present disclosure, it should not be constructed as limited to the specific embodiments disclosed, and modifications to the present disclosure and other embodiments are included in the scope of the attached claims. The present disclosure is defined by the claims and their equivalents.

1. A method for adjusting display brightness of a display panel, comprising:
partitioning a display picture into N display areas;
determining, for an i-th display area in a current frame, a brightness adjustment parameter for the i-th display area based on display data of the first to (i−1)-th display areas in the current frame; and
adjusting display brightness of the i-th display area in the current frame based on the brightness adjustment parameter, wherein N and i are positive integers greater than or equal to 2, and i is less than or equal to N.

2. The method of claim 1, wherein determining, for an i-th display area in a current frame, a brightness adjustment parameter for the i-th display area based on display data of the first to (i−1)-th display areas in the current frame comprises:
determining first brightness statistical data based on display data of the first to (i−1)-th display areas in the current frame, and determining second brightness statistical data based on display data of display areas in a previous frame; and
determining the brightness adjustment parameter based on the first brightness statistical data and the second brightness statistical data that are determined.

3. The method of claim 2, wherein determining first brightness statistical data comprises:
determining, for each display area of the first to (i−1)-th display areas in the current frame, brightness statistical data of the display area based on display data of the display area, respectively;
determining the first brightness statistical data based on the brightness statistical data of each display area among the first to (i−1)-th display areas in the current frame as determined.

4. The method of claim 2, wherein determining second brightness statistical data comprises:
determining the second brightness statistical data based on display data of the i-th to N-th display areas in the previous frame.

5. The method of claim 4, wherein determining second brightness statistical data further comprises:
determining, for each display area of the i-th to N-th display areas in the previous frame, brightness statistical data of the display area based on display data of the display area, respectively;
determining the second brightness statistical data based on the brightness statistical data of each display area of the i-th to N-th display areas in the previous frame as determined.

6. The method of claim 1, wherein, for each display area, the brightness statistical data thereof comprises at least one type of the following data:
a sum of display data at respective pixels in the display area;
the number of pixels where display data exceeds a set threshold in the display area.

7. The method of claim 2, wherein determining the brightness adjustment parameter based on the first brightness statistical data and the second brightness statistical data that are determined comprises:
summing the first brightness statistical data and the second brightness statistical data to determine total brightness statistical data;
determining, according to a preset mapping relationship, a brightness adjustment parameter corresponding to the total brightness statistical data, and using the determined brightness adjustment parameter as the brightness adjustment parameter for the i-th display area in the current frame.

8. The method of claim 1, wherein the display picture is determined to be partitioned into the N areas in the horizontal or vertical direction based on a driving manner of the pixels in the display picture.

9. The method of claim 1, wherein N=8.

10. A device for adjusting display brightness of a display panel, comprising:
one or more processors;
one or more memories,
wherein the memory is stored with computer-readable codes that, when being run by the one or more processors, execute the method of claim 1.

11. An apparatus for adjusting display brightness of a display panel, comprising:
a partitioning module configured to partition a display picture into N display areas;
a brightness adjustment parameter determining module configured to determine, for an i-th display area in a current frame, a brightness adjustment parameter for the i-th display area based on display data of the first to (i−1)-th display areas in the current frame; and
an adjusting module configured to adjust display brightness of the i-th display area in the current frame based on the brightness adjustment parameter, wherein N and i are positive integers greater than or equal to 2, and i is less than or equal to N.

12. A display device, comprising the apparatus for adjusting display brightness of a display panel of claim 11.

13. A non-transitory computer-readable storage medium having stored therein computer-readable codes that, when run by one or more processors, execute the method for adjusting display brightness of a display panel of claim 9.
